(19) United States
(12) Patent Application Publication
(10) Pub. No.: US 2015/0363870 A1
(43) Pub. Date: Dec. 17, 2015

(54) System and Method for SMS Ordering Via an Order Management System

(71) Applicant: Todd Ballinger, Silverthorne, CO (US)

(72) Inventor: Todd Ballinger, Silverthorne, CO (US)

(21) Appl. No.: 14/741,420

(22) Filed: Jun. 16, 2015

Related U.S. Application Data
(60) Provisional application No. 62/012,550, filed on Jun. 16, 2014.

(51) Int. Cl. G06Q 30/06; H04W 4/14; G06Q 50/12

(52) U.S. Cl. CPC G06Q 30/0635; G06Q 50/12; G06Q 30/0631; H04W 4/14

(57) ABSTRACT

Embodiments of the present invention are generally related to a system and a method that enables and encourages users to respond to a query with an SMS message containing a variety of potential words, phrases and other messages that affirmatively indicate that the user wishes to place an order based upon the suggestion previously delivered by the system to the user. The user may also place an order for an item other than the suggested item by delivering a different message. The user may also deliver a message indicating that the user declines to place an order.

### CROSS REFERENCE TO REFERENCE TO RELATED APPLICATIONS

This application claims the benefit of U.S. Provisional Patent Application 62/012,550, entitled “A SYSTEM FOR SMS ORDERING VIA AN ORDER MANAGEMENT SYSTEM” filed on Jun. 16, 2014, the entire contents of which are incorporated herein by reference in its entirety for all purposes.

### FIELD OF INVENTION

Embodiments of the present invention are generally related to a system and a method that enables and encourages users to respond to a query with an SMS message containing a variety of potential words, phrases and other messages that affirmatively indicate that the user wishes to place an order based upon the suggestion previously delivered by the system to the user. The user may also place an order for an item other than the suggested item by delivering a different message. The user may also deliver a message indicating declining to place an order.

### BACKGROUND OF THE INVENTION

A variety of devices and methods address the need for advance ordering and fulfillment of orders, particularly in food service, in institutional environments. Such devices and methods include face to face ordering to an order taker. In this context, the person wishing to place an order must typically wait in line prior to placing an order.

Other typical mechanisms utilized to deliver orders in advance include telephone based ordering, where the person wishing to place an order must call and speak to an order taker. However, such a mechanism cannot take place asynchronously, as both the person placing an order and the person receiving an order must simultaneously converse to process the order at the same time.

A problem associated with ordering paradigms such as the above is that such devices and methods necessitate human interaction. Thus, the ordering seldom takes place on an automated, mechanized basis. As a result, the capacity to receive and process such orders is limited by the human capacity for inter-person communication. This capacity constraint creates a significant problem for high-volume ordering contexts where the human resources available to process such orders is limited, such as, for example, the cafeterias of public schools.

The increased interest related to enabling more tailored ordering in food service requirements, particularly in schools, at least in part derives from a variety of high level initiatives to encourage healthier eating. Perhaps the most prominent of such initiatives is the “Let's Move” initiative, developed in conjunction with the White House Task Force on Childhood Obesity. Presently championed by First Lady Michelle Obama, the “Let's Move” initiative is dedicated to solving the challenge of childhood obesity within a generation. Among other tactics employed in conjunction with this initiative, recent guidelines adopted in conjunction with this initiative mandate the provision of healthier foods in schools throughout the United States.

A problem, however, associated with the “Let's Move” initiative and similar efforts are the difficulty associated with providing meals tailored to the health needs of students. Often, to meet the goals associated with healthier-eating initiatives, the preparers of food must tailor meals to specific dietary needs and preferences on a more individualized basis. A related problem derives from the need to receive orders in advance to empower food preparers to spend additional time necessary to prepare meals in such a way that meets the more complex requirements. Such challenges lead to potential increases in the wait times for such more complex food orders, when such orders are not efficiently received and process in advance. As a result, more effective planning must take place during the preparation of such meals.

Similar problems also exist in a variety of contexts other than food service-related contexts. Such problems often relate to the need to enable an easy method to communicate orders. In a variety of fields, the presence of complex and changing fulfillment requirements necessitates earlier and more efficient ordering systems. Yet, systems known in the prior art in a variety of contexts fail to allow the fulfillment of such orders utilizing ubiquitously used everyday devices already in the possession of those who wish to submit such orders.

In many contexts, orders cannot take place with a simple and ubiquitous mechanism. Thus, the sender of such an order must travel to a specific place or wait for a specific time to transmit the order. As a result, significant temporal and geospatial inefficiencies accompany ordering systems in many contexts.

### SUMMARY OF THE INVENTION

The present inventor has realized that a variety of inefficiencies may be addressed by linking commonly available, ubiquitous technologies with automated and human-facing order processing systems to generate suggestions for ordering to a user and then retrieve responses from the user leading to the placement of an order based upon the suggestions, leading to a separate order, or leading to no placement of an order. The system generates suggestions to a customer or user to order items based upon artificial intelligence gained from analysis of user preferences, ordering history and other data points. A system incorporating principles of the invention, therefore, incorporates steps to deliver SMS and other types of messages, including text messages, emails, push notifications, or other messaging means to query whether a user would like to place an order based upon said suggestions.

The system, in a certain embodiment of the invention, subsequently enables and encourages users to respond to the query message with an SMS message containing a variety of potential words, phrases and other messages that affirmatively indicate that the user wishes to place an order based upon the suggestion previously delivered by the system to the user. The user may also place an order for an item other than the suggested item by delivering a different message. The user may also deliver a message indicating that the user declines to place an order.

Certain embodiments can be used in a higher education setting. A user would receive a prompt based on the user's order history inquiring whether a user would like to order a meal. Based on the user's history, the prompt may inquire whether the user would like to place an order at the dormitory cafeteria. Or, if the user usually orders from a different facility, such as a student center or other on-campus eatery, the prompt would inquire whether the user would like to place an order at the student center. The user's response would be recorded and stored in the data storage module. Using the data, prompts can be refined.

Embodiments of the present invention can also be used in the health care industry. For example, user can be in a hospital setting. The user would receive a prompt based on the user's order history to inquiring whether the user would like to place an order for a meal. The user could then respond by ordering the meal or declining to order. If the user orders the meal, a prompt is sent to the kitchen to prepare the order. The order could then be picked up by the user, or delivered to the user. The user's response would then be recorded and stored in the data storage module. If the user decided not place an order, the system would determine to reduce the frequency of the particular prompt. If the user placed an order adopting the suggestion, the predictive coding would reflect the user's preference.

In yet another embodiment, a user can be at a sports and entertainment environment. For example, a user may decide to go to a concession stand to purchase a Levity beer from Odell's brewery and organic green chili smothered quinoa chip nachos at half-time during a football game. In certain embodiments, when halftime approaches, the user would receive a message with a prompt inquiring whether the user would like to purchase the typical order. If the user confirms, the system would then send a notification to the vendor who sells the Levity beer and organic green chili smothered quinoa chip nachos for preparation. At halftime, the user would then go to the vendor and pick up the order.

As those skilled in the art can appreciate, embodiments of the present invention can be used in the contract food service industry. The contract food service industry includes a broad range of industries, ranging from corporate settings, education (e.g. higher education, K-12), healthcare (e.g. hospitals, hospice, long term care), government, sports and entertainment (e.g. stadiums and concerts), and airline industries.

While various embodiments of the present invention have been described in detail, it is apparent that modifications and alterations of those embodiments will occur to those skilled in the art. However, it is expressly understood that such modifications and alterations are within the scope and spirit of the present invention, as set forth in the following claims. Further, the invention(s) described herein are capable of other embodiments and being practiced or of being carried out in various ways. In addition, it is to be understood that the phraseology and terminology used herein is for the purposes of description and should not be regarded as limiting. The use of “including,” “comprising,” or “adding,” and variations thereof herein are meant to encompass the items listed thereafter and equivalents thereof, as well as, additional items.

### BRIEF DESCRIPTION OF THE DRAWINGS

FIG. 1: Flow chart depiction of the ordering process

FIG. 2: Depiction of the order management system

### DETAILED DESCRIPTION OF CERTAIN EMBODIMENTS

In an embodiment incorporating principles of the invention, an order management system incorporates a variety of administrators, modalities, technologies and users to accomplish effective order management and advanced fulfillment of orders in an efficient manner. A certain embodiment of the invention incorporates steps to process orders through an order management system via short message service (SMS) technologies.

In certain embodiments, server initiates an ordering process by sending an order inquiry by text message to a user's mobile device prompting said user to place an order. The user sends an order by text message to the server. The server records the order. The server determines a party to which to send said order, based on the contents the order and then sends a notification to party with said order, wherein the notification is sent to said party to allow preparation of said order prior to said user arriving at a predetermined location for receipt of said order.

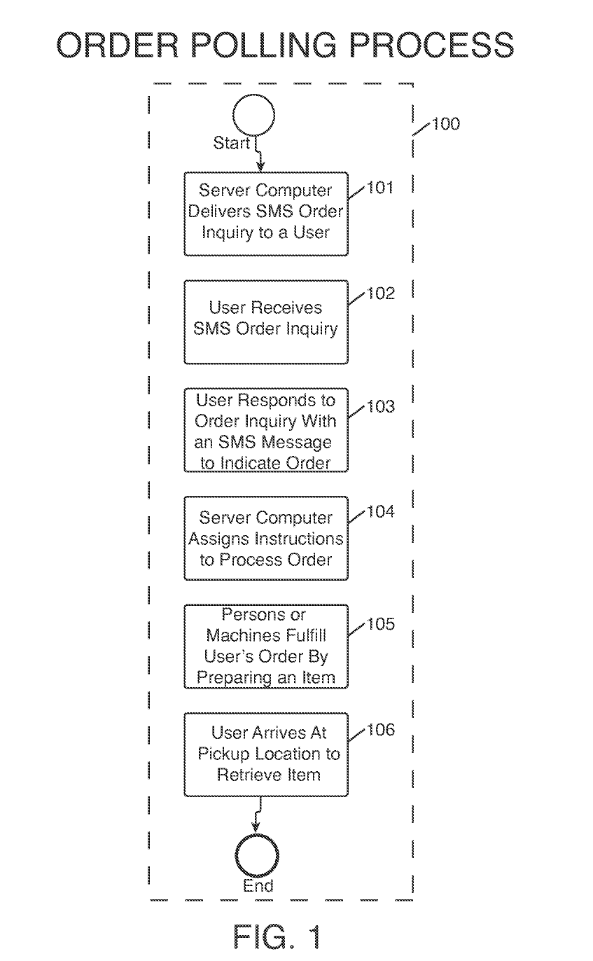

In certain embodiments, as seen in FIG. 1, a polling process 100 comprising a computer server interacts with a user to identify the user's order. The polling process 100 initiates with a SMS order inquiry step 101 to the user. A second step comprising the user receiving the SMS order inquiry 102 precedes the response of the user 103 with an SMS to the server computer to indicate his/her order. The following step of the polling process 100 comprises the receipt of the user's response and assigning instructions 104 wherein the server computer determines a party to which to send the order, based on the contents of the user's response message, for order preparation. The following step comprises the communication of the order to the determined party for order fulfillment 105. The order, prepared by the determined party, allows for the final step of the process wherein the user arrives at a predetermined location for receipt of his/her order 106.

It will be appreciated by one skilled in the art that a student according to preferences for receipt may use the process as demonstrated in FIG. 1 in a variety of scenarios including remote meal selection during a pre-determined lunch time-period at a school cafeteria.

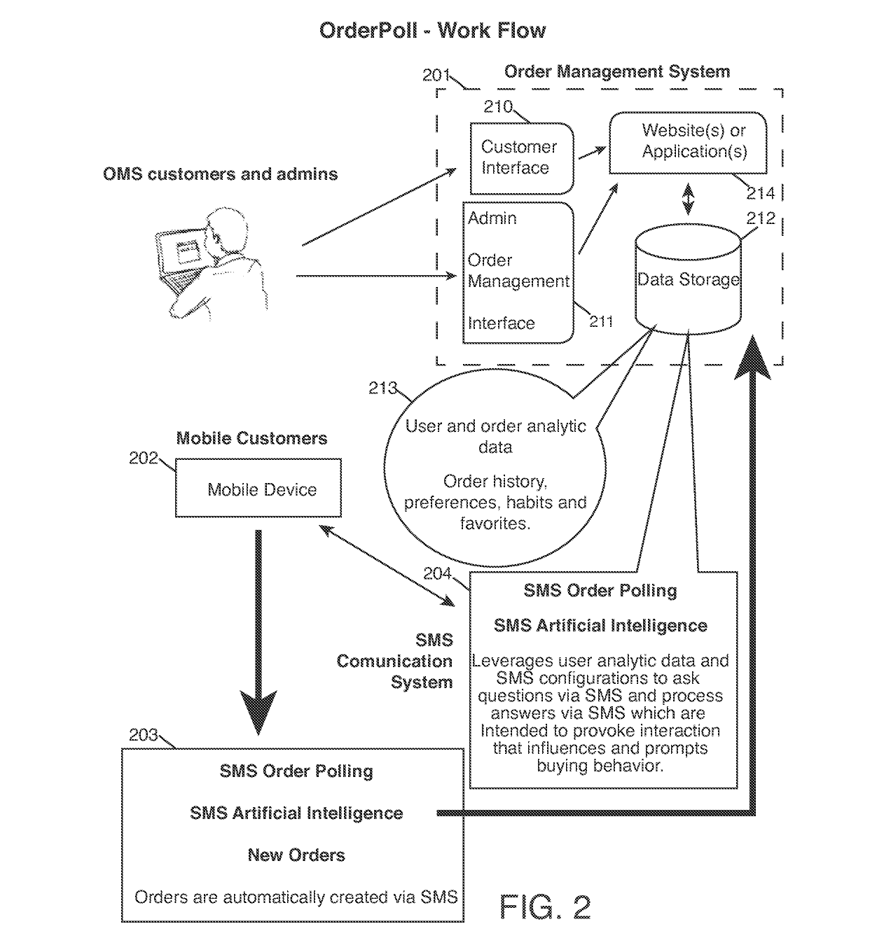

In certain embodiments of the invention, as shown in FIG. 2, an order management system 201 comprises a user interface 210, an administrator interface 211, website 213, data storage 212. The data storage enables the storage of analytic data 213 pertaining to users including but not limited to their order history, preferences, habit and favorites. In such an embodiment, the order management system provides an administrator interface 211 enabling administrators to manage the available selections, such as meal options available to students for a lunch time-period. Furthermore, a user interface 210 to provide information such as preferences, favorites and orders to supplement the analytic data 212 held in data storage 212. The order management system 201 leverages analytic data 213 to generate order-polling 204 wherein the directed questions and suggestions are used to initiate interactions with mobile users through text messages, typically an SMS message, to the mobile device 202 of a user. The user may respond in a natural language, including but not limited to slang and vernacular, to provide an affirmative, negative or modifying response to the suggested order through a message receiving center 203. The user may also initiate a new order through the same message receiving center 203.

In a system embodying principles of the invention, users utilize SMS technologies to send and receive information related to orders to an order management system. An order management system is accessible to users via both an interface accessible to users via websites or applications, and via technologies commonly leveraged by mobile devices, including SMS but also other technologies such as mobile apps. An order management system may have multiple access points, enabling administrative users and user users to access features of an order management system via SMS technologies, websites, applications and mobile devices in varying embodiments of the invention.

When accessing the order management system via a website or application, in an embodiment of the invention users have a comprehensive array of information accessible to them. Administrative users may access an administrative user interface or admin screen, enabling a user to access the specific users accessing orders. The administrative user interface enables administrative users to designate settings that create boundaries around the items available for ordering.

In certain embodiments incorporating principles of the invention, the administrative order management feature enables administrative users to retrieve and track orders. Administrative users can supersede instructions delivered by a user via SMS messaging, a mobile app, an internet screen or an internet-connected computer. The administrative order management feature also enables administrative users of the order management system to access and view analytics associated with users of the order management system. Administrative users can also access the administrative order management feature to set constraints associated with the ordering process. The administrative order management feature, in a certain embodiment of the invention, includes interactive features that allow administrative users to add, update or delete items that may be ordered via the order management system; designate the allowable timeframes within which a user may order such items; designate the times that query messages are delivered to users to poll whether users would like to initiate an order.

In certain embodiments of the invention, users may transmit orders to the system utilizing SMS after receiving an order query via SMS. A user first receives a query via SMS message inquiring whether said user would like to initiate an order. The specific content of the query via SMS message may vary based upon the intended recipient of the message and the specific context. For example, in the context of an order management system deployed within a school to process orders for food within a high school cafeteria, the content of the message may include slang terms and tone such as “You were cool with chicken strips last week, would you like the café to hook you up with that again for lunch today?” The content may be altered for other specific contexts. Subsequent to receiving the query via SMS, the user may initiate and deliver a responsive SMS order message to initiate or decline to initiate an order.

In certain embodiments of the invention, the order management system can take different forms. In a certain embodiment of the invention, the order management system is specifically designed to receive and process information via SMS. In other embodiments of the invention, information related to an order is transmitted via SMS to a third party order management system. As an example, a user may generate a SMS message to a third party order management system system to initiate an order through such an order management system system. In other embodiments, an individual person, rather than an automated machine-based system, may receive the content of an SMS message via a machine device and then initiate the order by preparing and delivering handwritten paper forms.

In yet another embodiments of the invention, the user order management feature incorporates a user interface that enables a user to initiate and track orders via SMS messaging, a mobile app, a website or an internet-connected computer interface. The user may send an SMS message containing predefined content to a predefined recipient to receive a responsive message containing the status of an order. Similarly, the user may send an SMS message to update, alter, or cancel an order already placed. A mobile app, a website or an internet-connected computer interface may also enable a user to accomplish the same tasks in varying embodiments of the invention.

In certain embodiments of the invention, server-based systems enable the generation of information related to user and order analytic data long with information inputted via the administrative interface and the user interface. Such user and analytic data incorporates identifying features of users, such as identifying attributes of a user's mobile devices. In most instances, the identifying attributes of a user's mobile devices includes a phone number, enabling systems associated with the order management system to associate information transmitted by the user via SMS with the user during the order fulfillment process. Other user and analytic data, either generated by an administrative user, a user, or via server based systems programmed to generate such information, includes order history, user preferences, user habits and user favorites. When server based systems generate such information, they do so via algorithmic analysis of the type, content and frequency of a user's prior orders. The analytic data enables the scheduled delivery of SMS messages timed to coincide with desired or habitual ordering times containing query messages asking a recipient user whether he or she would like to initiate an order. The order management system therefore enables orders to be processed over a greater timeframe, enabling the more efficient processing of orders despite increasing complexities associated with order fulfillment.

A server may also generate an SMS message to poll a user to request entry of an order in advance in a certain embodiment of the invention. Such a server- generated SMS message to a user may incorporate information generated by analysis of order history, user preferences, user habits and user favorites. For instance, the server may generate and deliver an SMS message to a user who has previously accessed a user administrative screen and designated a specific order as a user favorite with a query of whether said user wishes to place an order for said specific order designated as a user favorite.” In other circumstances, server-based algorithmic analysis may have independently evaluated a user's habits and may generate an SMS query message to such user to ask whether said user would like to place an a specific order, indicated as a user favorite by said server-based algorithmic analysis.

In certain embodiments of the invention, upon receipt of an SMS message querying whether the user wishes to place an order for a suggested item, the recipient user may respond with an SMS message with an indication to either place an order for the item, to place an order for a different item, or to indicate that no order is desired. The responsive SMS message is delivered to a server computer programmed to interpret the content of such responsive SMS message in a certain embodiment of the invention. In other embodiments of the invention, human users may receive the SMS message through computer-based or mobile devices.

In certain embodiments, the recipient of the user generated responsive message will interpret the message and then process the message's content accordingly. A responsive SMS message sent from a user (sent in response to an SMS message querying whether the user wishes to place an order for a suggested item) may contain slang words within such responsive SMS message, and the recipient of such responsive SMS message will interpret such slang terms as positive or negative indications and process accordingly. For instance, in the context of a the order management system specifically tailored for intended use by high school students' pre-ordering of cafeteria food, a human or computer recipient of the responsive SMS delivered by a user may receive the word “cool” within such responsive SMS. The recipient of the responsive SMS may interpret and subsequently process such slang word as an affirmative indication that the user wishes to order the item suggested in the original SMS message delivered to the user. In certain embodiments, a server or other connected data storage device contains a variety of slang terms and other natural language and associates instructions describing how to process each slang term in response to responsive SMS messages in the context of the intended environment of the order management system.

In certain embodiments of the invention, the order management system incorporates SMS-based order polling as a core feature. Order polling refers to the process of generating an item suggestion to a specific user and query to a specific user of whether said specific user wishes to order the item contained within said item suggestion. Such item suggestion may be based upon a specific user's order history, indicated preferences and other analytics relevant to said specific user. This analysis of user history results in analytics information stored, saved and subsequently usable as artificial intelligence. A server computer then generates a SMS message with said item suggestion content and said query. The server computer subsequently delivering the SMS message to said specific user. The said specific user may respond to the SMS message delivered to said specific user with an indication of whether the said specific user wishes to place an order for the item contained within said specific item suggestion.

The responsive SMS message sent from a user results in the generation of a new order in a certain embodiment of the invention. The SMS-based message constitutes a simplified mechanism to generate and deliver an order within the context of the SMS. A user, therefore, in addition to receiving an SMS item suggestion based upon analysis of the user's indicated preferences and order history, may simply respond with a responsive SMS to place the order. A server computer may receive and process the content of the responsive SMS to associate an order with the user delivering the responsive SMS. In this way, new orders are efficiently and efficiently generated. In other embodiments of the invention, a user may respond to an SMS item suggestion by placing an order via phone-connected or internet- connected user interface.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for ordering from a mobile device comprising:
a server that initiates an ordering process by sending an order inquiry by text message to a user's mobile device prompting said user to place an order;
said user sending an order by text message to said server;
said server recording said order;
said server determining a party to which to send said order, based on the contents of said order;
sending a notification to said party with said order;
wherein said notification is sent to said party to allow preparation of said order prior to said user arriving at a predetermined location for receipt of said order.

2. The method of claim 1 wherein said message is sent by short message service protocol.

3. The method of claim 1 wherein said order is a meal.

4. The method of claim 3 wherein said user is a student.

5. The method of claim 4 wherein said predetermined time is a scheduled mealtime.

6. The method of claim 5 wherein said predetermined location is a cafeteria.

7. An order management system comprising:
a user;
said user may place orders through an interface accessible from a web enabled computing device;
an administrator;
said administrator may add, delete or modify orders or item availability via an administrative interface;
a data storage module;
wherein said system interacts with users through a short message service protocol to receive an order from said user to be stored in said data storage module and transmitted to an appropriate party to prepare said order.

8. The order management system of claim 7 wherein an order history of said user is recalled from said data storage module to generate order suggestions to said user.

9. The order management system of claim 8 wherein said order management system initiates communication with said user by sending said user a text message to said user with said order suggestion.

10. The order management system of claim 9 wherein said text message is sent by short message service protocol.

11. The order management system of claim 9 wherein said system accepts and interprets natural language input from said user.
